(19) United States
(12) Patent Application Publication
(10) Pub. No.: US 2011/0073792 A1
(43) Pub. Date: Mar. 31, 2011

(54) Hemispherical Wedge Valve with Laminar Flow

(75) Inventor: Stanley C. Allen, Conroe, TX (US)

(73) Assignee: GILMORE VALVE COMPANY, Houston, TX (US)

(21) Appl. No.: 12/889,591

(22) Filed: Sep. 24, 2010

Related U.S. Application Data
(60) Provisional application No. 61/245,896, filed on Sep. 28, 2009.

(51) Int. Cl. F16K 1/54

(52) U.S. Cl. 251/205

(57) ABSTRACT

A valve having a hemispherical wedge closure member and including structure for maintaining laminar fluid flow through the valve body. The laminar fluid flow structure may include a solid core member with a plurality of discrete bores therethrough or a plurality of baffles extending longitudinal through a hollow core member. The laminar flow reduces noise, structural failure, erosion, cavitation, and premature wearing of valve seals and seats.

This application claims priority to provisional application Ser. No. 61/245,896 filed on Sep. 28, 2009

### BACKGROUND OF INVENTION

1. Field of the Invention

The present invention generally relates to an improved valve of the hemi-wedge type for use in the control of fluids in a pipeline. The valve of the present invention is particularly useful in providing both a tight shutoff of fluids when closed, a high flow when open, and includes a device for providing laminar flow through the valve body when in the open position.

2. Description of Related Art

Ball valves, plug, valves, and the like are well known to those skilled in the art. A common characteristic of these valves is that they may be moved from a full open position to a full closed position through an angle of no more than about ninety (90) degrees.

A simple ball valve comprises a rotatable ball having a bore therethrough corresponding to the fluid flow path, together with a seat for sealing with the ball surface. Ball valves permit fluid flow to be fully stopped by rotating the ball not more than about ninety (90) degrees. However, these valves offer only minimal graduated control of the fluid flow achieved by setting the ball at intermediate positions. Further, these valves are placed in the open or close position without a mechanical force applied by the closure member against a seat.

A simple plug valve comprises a rotatable tapered plug having a bore therethrough disposed in a complementary housing. The plug permits flow to be fully stopped by rotating the plug more than about ninety (90) degrees. Plug valves operate similarly to the previously described ball valve and offer similar advantages and disadvantages.

Gate valves, globe valves and the like are also well known to those skilled in the art. A common characteristic of these valves is that they may be moved from a full open position to a full closed position by the rising and lowering of a valve stem acting on a closure member (gate in a gate valve or disc or plug in a globe valve). These valves offer sealing advantages over ball valves, but take longer to open or close and generally have a higher leakage of fluid to the atmosphere with the rising and lowering of the stem.

A valve offering significant advantages over conventional ball, plug, gate, and globe valves is the hemi-wedge valve described in U.S. Pat. No. 4,962,911, and improved with a valve driver in U.S. Pat. No. 5,333,834, and improved with a cartridge feature for quick and easy repair in U.S. Pat. No. 7,484,523. The contents of these three patents are expressly incorporate herein by reference thereto. The hemi-wedge valve includes a curved wedge comprising a tapered, spherical section rotatable through the fluid path and cooperating with a complementary curved seat to affect a shut off. An important feature of the hemi-wedge valve is that the thickness of the wedge increases from its leading end to its trailing end. The wedge includes a round bore forming a part of the fluid path through its thinner, leading end. The wedge is solid and thicker at its trailing end. Rotation of the hemi-wedge through about ninety (90) degrees into the fluid path closes the fluid path by blocking it with the solid and thicker end of the wedge. This provides a mechanical loading of the seat.

A shortcoming of the existing designs is that they do not provide a mechanism for establishing and maintaining laminar flow of the fluid through the valve when the valve is in the open position.

### BRIEF SUMMARY OF THE INVENTION

The present invention is directed to a mechanism for insuring that the flow through a hemi-wedge type valve remains laminar. Non-laminar flow can result in excessive noise, structural failure, erosion, cavitation, and premature wearing of valve seals and seats. In one embodiment laminar flow is accomplished by forming the core of the hemi wedge as a solid member having a plurality of parallel flowpaths throughout its length. Other embodiments are disclosed.

This divides the flow of the fluid at the inlet of the valve into a plurality of parallel flow paths which eliminates turbulence in the main flowpath and results in laminar flow through the valve body.

### BRIEF DESCRIPTION OF THE SEVERAL VIEWS OF THE DRAWING(S)

FIG. 1 is a cross sectional view of a typical hemi-wedge valve.

FIG. 2 is a perspective view of a valve core body for a hemi-wedge valve according to one embodiment of the invention.

FIG. 3 is a cross sectional view of the valve core body of FIG. 2

FIG. 4 is a front view of a second embodiment of the laminar flow device.

FIG. 5 is a front view of another embodiment of the laminar flow device.

FIG. 6 is a front view of a further embodiment of the laminar flow device.

### DETAILED DESCRIPTION OF THE INVENTION

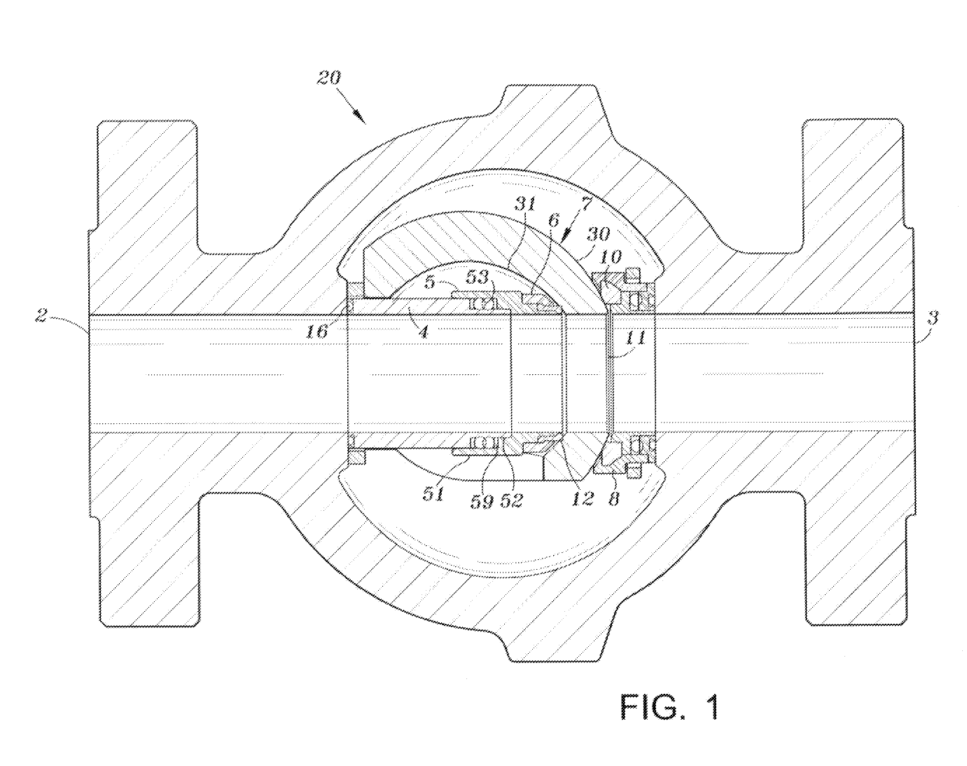

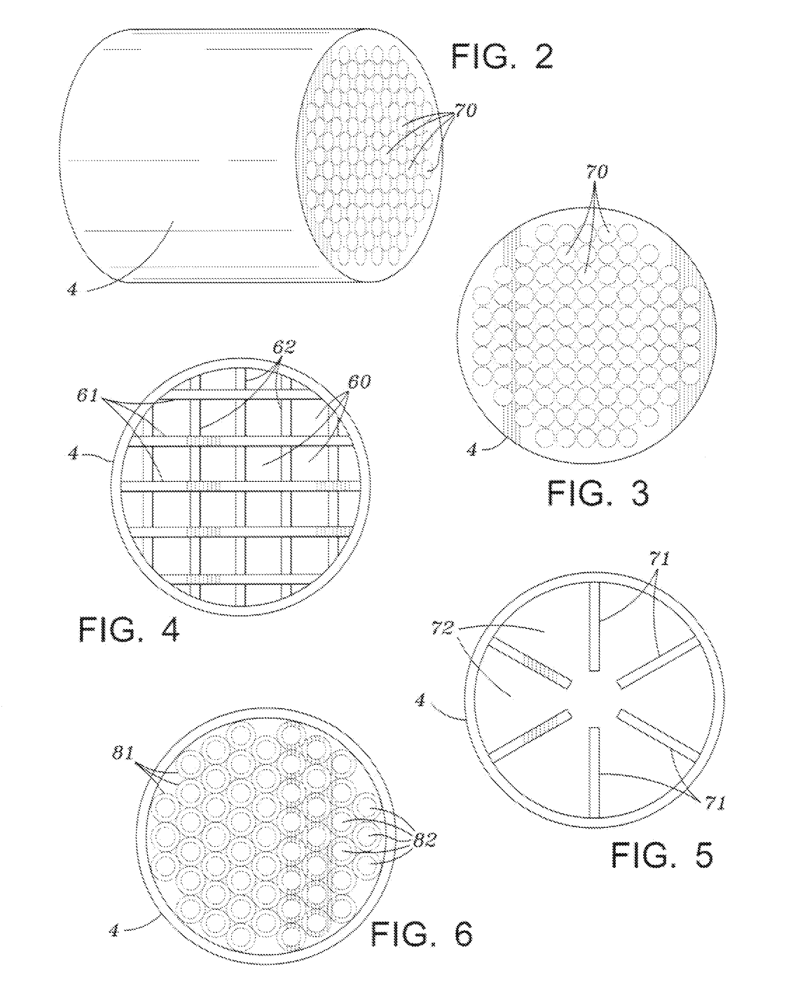

Referring to FIG. 1, a hemi-wedge valve 20 is shown including an inlet 2, a core section comprising two cylindrical hollow body members 4, 5, and an outlet 3. A hemi-wedge valve element 7 is rotatably mounted in the valve 20. The thickness of the hemi wedge valve element increases from the leading edge to the trailing edge which results in an improved seal. The operation of the wedge is described in detail in U.S. Pat. No. 4,962,911, the contents of which is expressly incorporated herein by reference thereto. In order to maintain laminar flow, a solid valve core member 4 as shown in FIG. 2 that includes a plurality of separate flow paths 70 is provided. The valve also includes various seals 16, 53, 12, 10. Core member 5 includes a first cylindrical portion 51, a first shoulder 59 and a second cylindrical portion 52 that receive complimentary shaped portions on the core member 4. Hemi-wedge valve element 7 includes inner and outer curved surfaces 31 and 30. A downstream valve seat 8 holds seal 10. The particular arrangement of the hemi-wedge valve shown in FIG. 1 results in a dual valve seat arrangement that includes inner and outer surfaces 31 and 30 and seals 12 and 10 respectively.

While the valve core may consist of two separate elements as shown in FIG. 1, the valve core may be a unitary piece as shown in the above mentioned U.S. Pat. No. 4,962,911. This invention is suitable for use in the various designs of hemi wedge valves of the prior art that utilize a core member. Other laminar flow techniques may be used such as shown in FIGS. 4-6.

In FIG. 4 the parallel flow paths 60 are formed by a plurality of axially extending baffles 61 and 62 that intersect at right angles. The baffles could be either vertically or horizontally extending or both as shown.

FIG. 5 discloses another embodiment of the laminar flow device. In this embodiment, the core member is provided with a plurality of axially and radially extending baffles 71 that form separate flow paths 72.

In FIG. 6, parallel flow paths 82 are formed by a plurality of discrete flow tubes 81 positioned within the core member.

FIG. 6 discloses a further embodiment wherein a plurality of axially extending tubes 81 are located within the core member 4 thereby forming a plurality of parallel passages 82.

The parallel flow passages could extend for the entire length of core members 4, 5 or only through a portion thereof. Although the present invention has been described with respect to specific details, it is not intended that such details should be regarded as limitations on the scope of the invention, except to the extent they are included in the accompanying claims.

I claim:

1. A valve comprising:
a housing;

2. a fluid inlet and a fluid outlet in the housing;
a flow path connecting the fluid inlet to the fluid outlet;
a valve core member forming a portion of the fluid flow path, the valve core member including a plurality of discrete parallel flow paths; and
a hemi wedge valve member located within the housing for selectively opening and closing the flow path.

3. A valve according to claim 1 wherein the discrete parallel flow paths are formed by a solid valve core member having a plurality of longitudinally extending bores provided therethrough.

4. A valve according to claim 1 wherein the discrete parallel flow parts are formed by a plurality of axially extending intersecting plate members.

5. A valve according to claim 1 wherein the discrete parallel flow paths are formed by a plurality of radially and axially extending baffles.

6. A valve according to claim 1 wherein the discrete parallel flow paths are formed by a plurality of discrete flow tubes positioned within the valve core member.
